(19) United States
(12) Patent Application Publication
(10) Pub. No.: US 2009/0158554 A1
(43) Pub. Date: Jun. 25, 2009

(54) Positioning Device for Hinge Structure

(76) Inventors: Kuo-Feng CHANG, Sinjhuang City (TW); Chen Hao WU, Sinjhuang City (TW)

Correspondence Address: Guice Patents PLLC, 12647 Galveston Court #302, Manassas, VA, 20112, US

(21) Appl. No.: 12/272,840

(22) Filed: Nov. 18, 2008

(30) Foreign Application Priority Data
Dec. 25, 2007 (TW) 096149856

(51) Int. Cl. E05D 7/06

(52) U.S. Cl. 16/241

(57) ABSTRACT

The present invention discloses a positioning device for hinge structure, comprising a fixed part, a rotatable part, a pivotal axle, at least an elastic part, a nut, and a cam member. The pivotal axle is passed through the first pivotal portion of the fixed part and the second pivotal portion of the rotatable part to render the rotatable part rotating relative to the fixed part and with respect to the pivotal axle. Consequently, through the rotation of the cam member, the contacts of the first and second contact faces with a pivoting portion is alternated and thus the distance between the contact faces and the pivotal portion is changed, rendering the nut pressing against or relaxing from at least one elastic part. The axial frictional force generated between the fixed part and the rotatable part is therefore changed so as to achieve positioning or rotation of the fixed part and the rotatable part.

### FIELD OF THE INVENTION

The present invention relates to a positioning device and, in particular to a positioning device for hinge structure.

### BACKGROUND OF THE INVENTION

It is common to see two objects being rotated angularly relative to each other to open or close, door panel for example. On the other hand, it is also common to see devices which are flipped open to operate or closed to power off, commonly seen portable computer, electronic dictionary, portable audio/video player, and so on for example.

Recently, flat panel displays, such as liquid crystal display (LCD) monitors, LCD TVs, or plasma TVs, have the advantages of lightweight, thinness, and radiation-free and thus have gradually replaced conventional cathode ray tube (CRT) monitors. Consequently, a supporting element with a rotating axle has become an essential accessory for flat panel displays.

The exploded perspective view and cross-sectional assembly view of the “Positioning Structure for Supporting Frame” disclosed in the ROC Patent No. M310569 are shown in FIGS. 1a and 1b. The invention mainly comprises a first supporting arm 10, a second supporting arm 30, at least a fixed axle 20, and a positioning assembly 40. The upper end of the first supporting arm 10 and the lower end of the supporting arm 30 are horizontally pivoted onto the fixed axle 20. The positioning assembly 40 is socketingly connected to the fixed axle 20 and is disposed between the first and second supporting arms 10, 30. The positioning assembly 40 has an adjoining first spring plate 401 and second spring plate 402 side by side, which are socketingly connected to the fixed axle 20, respectively. The first spring plate 401 is secured onto the first supporting arm 10 and the second spring plate 402 is secured onto the second supporting arm 30. Further, at least a first positioning portion 403 and at least a second positioning portion 404 are correspondingly formed at the adjoining faces of the first and second spring plates in equal spacing.

When implemented, the first positioning portion 403 and the second positioning 404 can both be protruded blocks or a protruded block and a notch, such that when the second supporting arm 30 is rotated with respect to the first supporting arm 10, the second spring plate 402 rotates along the first spring plate 401 and thus the protruded block is abutted against the other protruded block or the protruded block is engaged onto the notch, thereby establishing a positioning relationship.

Although the conventional art described above can achieve positioning function for the two supporting arms, the operation is not perfect. Users, for example, have to turn one supporting arm to rotate with respect to the other supporting arm, such that the first and second positioning portions of the first and second spring plates can achieve positioning relationship; also, the first and second positioning portions are pre-fabricated at a specific angle between the first and second spring plates, and this should be classified as a stepwise positioning. Consequently, there is still room for improvement in the structure of the conventional art described.

### SUMMARY OF THE INVENTION

In view of the foregoing shortcomings of the prior art, the inventor of the present invention based on many years of experience in technology of hinge structure hopes to improve the drawback of falling to provide stepless positioning function in the hinge structure of a supporting frame. The aim is to present a positioning device which is quick in operation and firm in positioning for the hinge structure today. After numerous experiments and tests, a positioning device for hinge structure according to the present invention is developed.

The main object and the improvement of the present invention is to provide a stepless positioning function for hinge structure which, through the rotation of a cam member, the contacts of the first and second contact faces with a pivoting portion is alternated and thus the distance between the contact faces to the pivotal portion is changed, rendering a nut pressing against or relaxing from at least one elastic part so as to increase the axial frictional force between a fixed part and a rotatable part to obtain a stepless positioning function; alternately, maintain the original frictional force between the fixed part and the rotatable part to provide the function of rotation.

In order to accomplish the object described above, the present invention provides a positioning device for hinge structure, comprising a fixed part disposed with a first pivotal portion; a rotatable part disposed with a second pivotal portion, which adjoins the first pivotal portion; a pivotal axle which is inserted through the first and second pivotal portions through its one end to render the rotatable part rotating relative to the fixed part and with respect to the pivotal axle, whose inner section is insertingly connected with at least an elastic part, whose connection segment at its inner end is connected with a nut, and whose other end is disposed with a connection portion; a cam member whose linking portion at one end adjoins a pivotal portion, is rotatably pivoted to the connection portion, and is disposed with a first contact face axially and second contact face radially, and the distances between the two contact faces and the pivot are different. Consequently, through the rotation of the cam member, the contacts of the first and second contact faces with a pivoting portion is alternated and thus the distance between the contact faces and the pivotal portion is changed, rendering the nut pressing against or relaxing from at least one elastic part. The axial frictional force generated between the fixed part and the rotatable part is therefore changed so as to achieve positioning or rotation of the fixed part and the rotatable part.

The present invention further provides a positioning device for hinge structure, comprising a fixed part disposed with a first pivotal portion; a rotatable part disposed with a second pivotal portion, which adjoins the first pivotal portion; a pivotal axle which is inserted through the first and second pivotal portions through its one end to render the rotatable part rotating relative to the fixed part and with respect to the pivotal axle, whose inner section is insertingly connected with at least an elastic part, whose connection segment at its inner end is connected with a nut, and whose other end is disposed with a connection portion; a cam member whose linking portion at one end is disposed with a relay tube between a pivotal portion for the insertion of the pivotal axle, is rotatably pivoted to the connection portion, and is disposed with a first contact face axially and second contact face radially, and the distances between the two contact faces and the pivot are different. Consequently, through the rotation of the cam member, the contacts of the first and second contact faces with a pivoting portion is alternated and thus the distance between the contact faces and the pivotal portion is changed, rendering the nut pressing against or relaxing from at least one elastic part. The axial frictional force generated between the fixed part and the rotatable part is therefore changed so as to achieve positioning or rotation of the fixed part and the rotatable part.

### BRIEF DESCRIPTION OF THE DRAWINGS

The present invention can be more fully understood by reference to the following description and accompanying drawings, in which:

FIGS. 1a and 1b are a perspective assembly view and a cross-sectional assembly view of a prior art, respectively;

FIG. 2 is an exploded perspective view of the positioning device for hinge structure of the present invention;

FIG. 3 is a perspective assembly view of the present invention;

FIG. 4 is a cross-sectional assembly view of the present invention at the un-operated state; and

FIG. 5 is a cross-sectional assembly view of the present invention at the operated state.

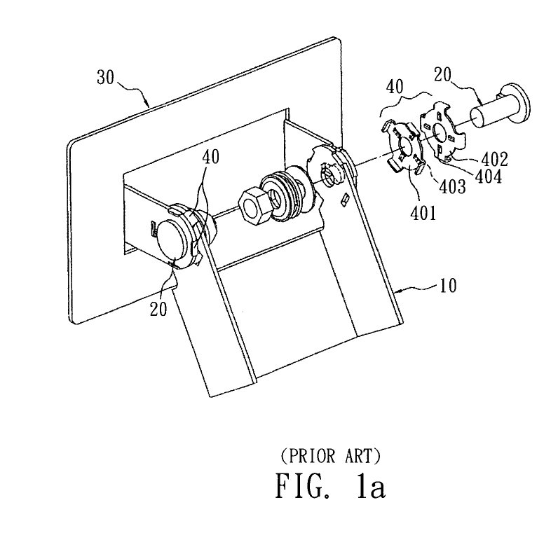

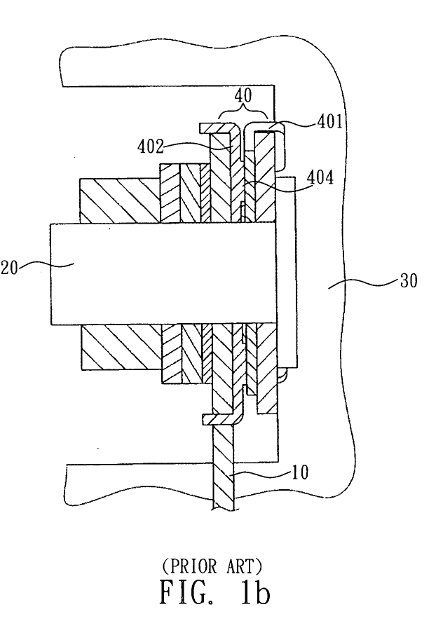

### DETAILED DESCRIPTION OF THE INVENTION

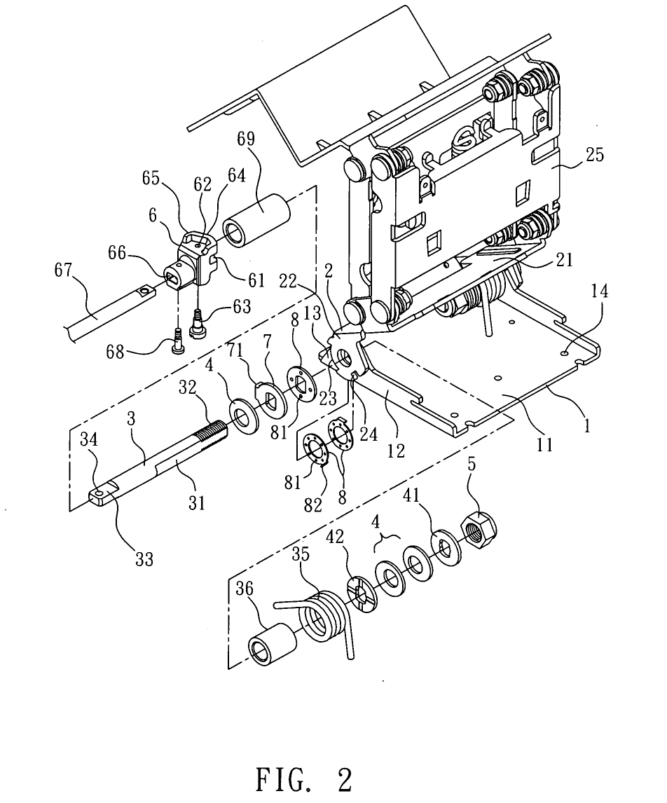

As shown in FIGS. 2 to 4, a positioning device for hinge structure according to the present invention comprises a fixed part 1, a rotatable part 2, a pivotal axle 3, at least an elastic part 4, a nut 5, and a cam member 6.

The fixed part 1 and the rotatable part 2, which are conventional parts, are attached together and then connected with the pivotal axle 3, such that the rotatable part 2 may rotate with respective to the fixed part 1 to adjust the opening angle between them.

The fixed part 1 is a base plate 11 disposed with a wing plate 12 extending vertically from its two opposite sides, respectively, and a first pivotal portion 13 is formed at one end of the base plate 11 for the insertion of the pivotal axle 3, wherein the surface of the base plate 11 is formed to have a plurality of through holes 14, which are inserted with conventional fastening elements, screw for example, and secured onto a base.

The rotatable part 2 is a frame plate 21 vertically disposed with a second pivotal portion 22, protruded ear for example, from its two opposite sides, respectively. After the pivotal axle 3 is inserted through, the second pivotal portions 22 is positioned next to and at, for example but not limited to, the outer side of the first pivotal portion 13; the second pivotal portion 22 may also be positioned next to and at the inner side of the first pivotal portion 13, such that the rotatable part 2 may be rotated relative to the fixed part 1 and with respect to the pivotal axle 3, wherein the frame plate 21 of the rotatable part 2 may be connected with a supporting frame 25 to support a supported object.

The pivotal axle 3 is a bar body, which passes the first pivotal portion 13 of the fixed part 1 and the second pivotal portion 22 of the rotatable part 2 to render the rotatable part 2 rotating relative to the fixed part 1 and with respect to the pivotal axle 3, and thus achieve the function of hinge structure. As shown in FIG. 2, the bar body of the pivotal axle 3 is formed to have at least a flat face 31, and the shape of the first pivotal portion 13 is identical to the cross-section of the pivotal axle 3. The inner end of the pivotal axle 3 is formed to have a connection segment 32, a screw segment for example, which is, in the order of, insertingly connected with at least an elastic part 4 and screwed with a nut 5 at inner side of the first pivotal portion 13, so as to form a secure connection. By the connection depth of the nut 5 onto the connection segment 32, an axial force is exerted on the elastic part 4. Further, the other end of the pivotal axle 3 is formed to have a connection portion 33, an inserted handle for example, which is radially formed to have a pin hole 34 to be pivotally connected with the cam member 6 described latter, such that the cam member 6 may swingingly rotate to pull or release the pivotal axle 3.

The elastic part 4 is preferably to be a plurality of spring discs of springs when implemented, as shown in FIG. 2. In the present invention, the elastic part 4 is embodied as a plurality of spring discs, which have arc faces and are alternately inserted with either face at the inner side of the pivotal axle 3.

To enhance the supporting effect of the fixed part 1 and the rotatable part 2, a torsion spring 35 is disposed therebetween for the insertion of the pivotal axle 3 and positioned between the elastic part 4 and the first pivotal portion 13. The ends of the torsion spring 35 are abutted against the fixed part 1 and the rotatable part 2, respectively, generating a force whose direction is opposite to the forward rotation of a supported object connected with a supporting frame 25 over the rotatable part 2. Consequently, the install of the torsion spring 35 renders the rotatable part 2 having an inclined angle with respect to the fixed part 1. To prevent the torsion spring 35 from distorting when in its energy-stored or energy-released state, the torsion spring 35 is enclosingly inserted with a sleeve 36, which is also inserted through by the pivotal axle 3. Further, a gasket 41 is disposed between the elastic part 4 and the nut 5 as well as the elastic part 4 and the torsion spring 35, respectively. The sides of the gaskets 41 facing the nut 5 and the torsion spring 35 are formed to have a cross-shape oil groove 42, respectively, to receive lubricating oil for lubrication.

The cam member 6 is a base body disposed with at one end a linking portion 61, a notch for example, for the inserting and embedding of the connection portion 33 at the outer side of the pivotal axle 3, and an axle pin 63 is passed through the positioning hole 62 of the linking portion 61 and the pin hole 34 of the connection portion 33 to establish a connection and to act as a pivot. The linking portion 61 of the cam member 6 is disposed with a first contact face 64 axially and second contact face 65 radially. The distance between the first contact face 64 and the pivot (axle pin 63) is smaller than that between the second contact face 65 and the pivot (axle pin 63). Consequently, when the cam member 6 is driven, it is rotated from the first contact face 64 to the second contact face 65, i.e. from short side to the long side, so as to pull the pivotal axle 3 in axial direction. Also, for the convenient rotation of the cam member 6 and thus saving labor, the movable end of the cam member 6 is disposed with a joining portion 66, an inserted notch for example, for the insertion of the handle 67 and a lock pin 68 is mounted to connect together the joining portion 66 and the handle 67. Consequently, when the handle 67 is operated, the cam member 6 may swingingly rotate with respect to the pivot axle 3.

When the cam member 6 is rotated from the first contact face 64 to the second face 65, the cam member 6 may directly contact with the second pivotal portion 22 of the rotatable part 2, leading to a possible interference. Increasing the operation distance can prevent the interference from occurring. Consequently, a relay tube 69 may be disposed between the cam member 6 and the second pivotal portion 22 for the insertion of the pivotal axle 3 so as to increase the operation length.

Further, the periphery of the second pivotal portion 22 is disposed with a positioning portion 23, a fan-shape notch for example, and the pivotal axle 3 adjoining the second pivotal portion 22 is insertingly disposed with a stopper 7, whose periphery is protrudingly disposed with a stopping portion 71, which protrudes into the positioning portion 23. When the rotatable part 2 is rotated, the positioning portion 23 of the rotatable part 2 may be abutted against the stopping portion 71 of the stopper 7 and thus limit the rotation angle of the rotatable part 2. An additional elastic part 4 may be disposed between the stopper 7 and its adjoining relay tube 69, so as to exert an axial elastic force onto the stopper 7.

Further, to prevent the frictional parts; the first pivotal portion 13, the second pivotal part 22, and the stopper 7 for example; from wearing too much, a wear resistant plate 8 is disposed between the frictional parts, respectively. Each wear resistant plate 8 is inserted by the pivotal axle 3 and is formed to have a plurality of oil holes 81 on its surface to receive lubricating oil. Also, to enable the wear resistant plates 8 secured at the adjoining faces of the first pivotal portion 13 and the second pivotal portion 22, the periphery of the wear resistant plate 8 is protrudingly disposed with an engagement tenon 82 so as to be engaged into the engagement slots 24 pre-formed at the pivotal portion 13 and the second pivotal portion 22, respectively (the engagement slot of the first pivotal portion 13 cannot be seen because of projection angle.).

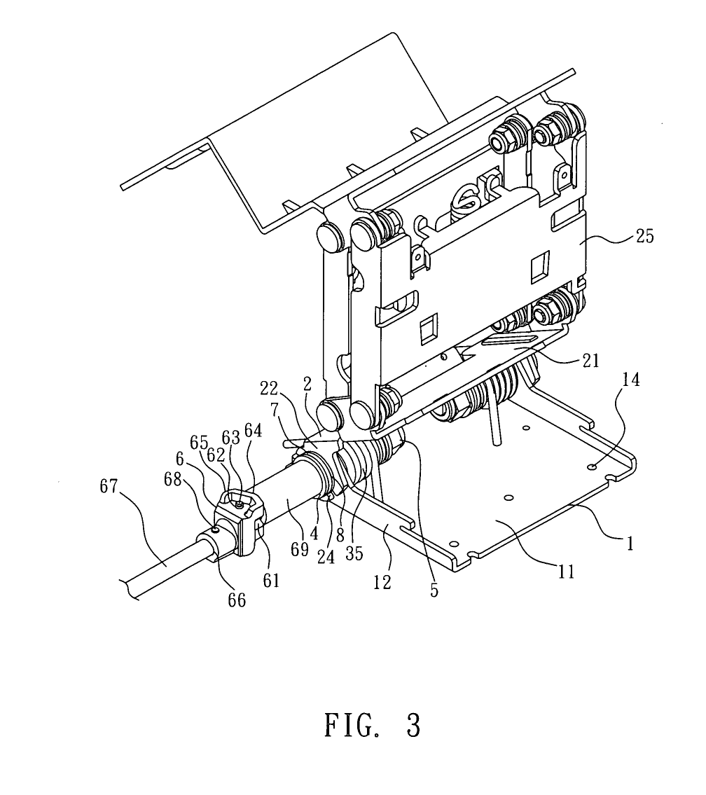

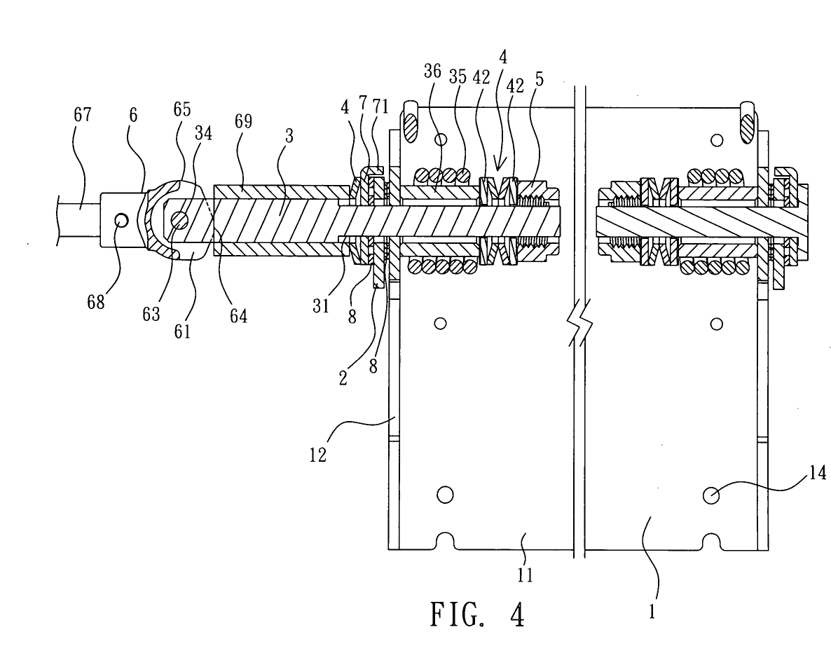

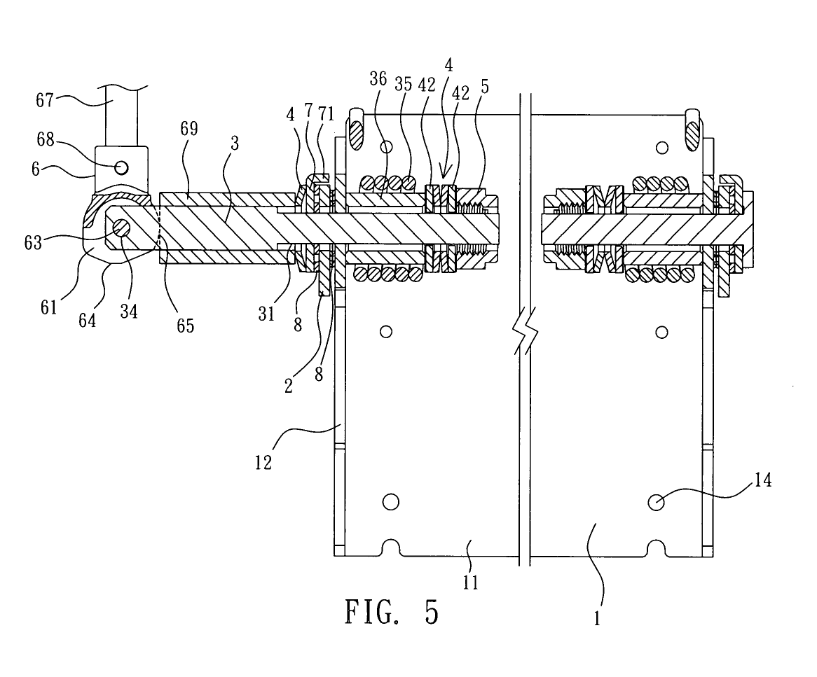

FIG. 3 is a perspective assembly view of the elements described above according to the present invention. FIG. 4 is a cross-sectional assembly view of FIG. 3, exhibiting the un-operated state. From the position, the rotatable part 2 may be rotated relative to the fixed part 1 and with respect to the pivotal axle 3 and the elastic part 4 provides adequate frictional force to enable the rotatable part 2 adjusting its inclined angle within its positioning portion 23. When an inclined angle is being adjusted, as shown in FIG. 5, a user may rotate the cam member 6 by the handle 67, such that the contact between the first contact face 64 and the end face of the relay tube 69 is changed to the contact between the second contact face 65 and the end face of the relay tube 69. Such a distance change due to rotating from short side to long side pulls axially the pivotal axle 3, and then the nut 5 at the inner side pushes and squeezes the elastic part 4, further strengthening the axial frictional force between the fixed part 1 and the rotatable part 2. Consequently, a stepless positioning can be achieved.

On the other hand, if the original frictional force between the fixed part 1 and the rotatable part 2 is required, the handle 67 is pulled toward the opposite direction, and the pivotal axle 3 is retracted due to the extension of the elastic part 4. Thus, the original frictional force between the fixed part 1 and the rotatable part 2 is maintained so as to initiate rotation.

Consequently, with the implementation of the present invention, a positioning device may be disposed at a hinge structure, and through the rotation of a cam member, the contact between a first contact face with a pivotal portion into between a second contact face with the pivotal portion is changed. The distance change resulted from the alternate contact of the contact faces and the pivotal portion moves a pivotal axle, such that a nut is pressed against or released from at least an elastic part to increase the axial frictional force between a fixed part and a rotatable part. Consequently, a stepless positioning can be achieved; alternately, the original frictional force between the fixed part and the rotatable part is maintained to initiate rotation. The present invention can thus overcome the drawbacks of conventional art and is indeed a breakthrough of its kind.

It is appreciated that although the directional practice device of the present invention is used in a very limited space instead of practicing at the real playing field, effective and steady practice can be obtained as well. Further, it is very easy to set up and to operate the directional practice device of the present invention. These advantages are not possible to achieve with the prior art.

While the invention has been described with reference to the a preferred embodiment thereof, it is to be understood that modifications or variations may be easily made without departing from the spirit of this invention, which is defined by the appended claims.

What is claimed is:

1. A positioning device for hinge structure, comprising
a fixed part disposed with a first pivotal portion;
a rotatable part disposed with a second pivotal portion, which adjoins the first pivotal portion;
a pivotal axle which is inserted through the first and second pivotal portions through its one end to render the rotatable part rotating relative to the fixed part and with respect to the pivotal axle, whose inner section is insertingly connected with at least an elastic part, whose connection segment at its inner end is connected with a nut, and whose other end is disposed with a connection portion;
a cam member whose linking portion at one end adjoins a pivotal portion, is rotatably pivoted to the connection portion, and is disposed with a first contact face axially and second contact face radially, and the distances between the two contact faces and the pivot are different;
consequently, through the rotation of the cam member, the contacts of the first and second contact faces with a pivoting portion is alternated and thus the distance between the contact faces and the pivotal portion is changed, rendering the nut pressing against or relaxing from at least one elastic part, and the axial frictional force generated between the fixed part and the rotatable part is therefore changed so as to achieve positioning or rotation of the fixed part and the rotatable part.

2. The positioning device for hinge structure as defined in claim 1, wherein the second pivotal portion is disposed with a positioning portion, and the pivotal axle adjoining the second pivotal portion is insertingly disposed with a stopper, whose periphery is protrudingly disposed with a stopping portion; when the rotatable part is rotated, the positioning portion of the rotatable part may be abutted against the stopping portion of the stopper and thus limit the rotation angle of the rotatable part.

3. The positioning device for hinge structure as defined in claim 2, wherein a wear resistant plate is disposed between the stopper and the second pivotal portion for the insertion of the pivotal axle and is formed to have a plurality of oil holes on its surface to receive lubricating oil.

4. The positioning device for hinge structure as defined in claim 1, wherein the elastic part is a plurality of spring discs which have arc faces and are alternately inserted with either side at the pivotal axle.

5. The positioning device for hinge structure as defined in claim 1, wherein the elastic part is a spring.

6. The positioning device for hinge structure as defined in claim 1, wherein at least a wear resistant plate is disposed between the first and second pivotal portions and is formed to have a plurality of oil holes on its surface, and each wear resistant plate is protrudingly disposed with an engagement tenon so as to be engaged into the engagement slots pre-formed at an adjoining pivotal portion.

7. The positioning device for hinge structure as defined in claim 1, wherein a torsion spring is disposed between the fixed part and the movable part and enclosingly inserted with a sleeve before being inserted by the pivotal axle, and the ends of the torsion spring are abutted against the fixed part and the rotatable part, respectively.

8. The positioning device for hinge structure as defined in claim 1, wherein the linking portion is a notch, the connection portion is an inserted handle, which is inserted into the notch, and an axle pin is passed through the positioning hole of the notch and the pin hole of the inserted handle to establish a rotatable pivotal connection.

9. The positioning device for hinge structure as defined in claim 1, wherein the movable end of the cam member is connected with a handle.

10. The positioning device for hinge structure as defined in claim 1, wherein a gasket is disposed at both sides of the elastic part for the insertion of the pivotal axle and formed to have oil grooves at its surfaces.

11. A positioning device for hinge structure, comprising
a fixed part disposed with a first pivotal portion;
a rotatable part disposed with a second pivotal portion, which adjoins the first pivotal portion;
a pivotal axle which is inserted through the first and second pivotal portions through its one end to render the rotatable part rotating relative to the fixed part and with respect to the pivotal axle, whose inner section is insertingly connected with at least an elastic part, whose connection segment at its inner end is connected with a nut, and whose other end is disposed with a connection portion;
a cam member whose linking portion at one end is disposed with a relay tube between a pivotal portion for the insertion of the pivotal axle, is rotatably pivoted to the connection portion, and is disposed with a first contact face axially and second contact face radially, and the distances between the two contact faces and the pivot are different;
consequently, through the rotation of the cam member, the contacts of the first and second contact faces with a pivoting portion is alternated and thus the distance between the contact faces and the pivotal portion is changed, rendering the nut pressing against or relaxing from at least one elastic part, and the axial frictional force generated between the fixed part and the rotatable part is therefore changed so as to achieve positioning or rotation of the fixed part and the rotatable part.

12. The positioning device for hinge structure as defined in claim 11, wherein the second pivotal portion is disposed with a positioning portion, and the pivotal axle adjoining the second pivotal portion is insertingly disposed with a stopper, whose periphery is protrudingly disposed with a stopping portion; when the rotatable part is rotated, the positioning portion of the rotatable part may be abutted against the stopping portion of the stopper and thus limit the rotation angle of the rotatable part.

13. The positioning device for hinge structure as defined in claim 12, wherein a wear resistant plate is disposed between the stopper and the second pivotal portion for the insertion of the pivotal axle and is formed to have a plurality of oil holes on its surface to receive lubricating oil.

14. The positioning device for hinge structure as defined in claim 12, wherein an elastic part is insertingly disposed between the stopper and the relay tube.

15. The positioning device for hinge structure as defined in claim 11, wherein the elastic part is a plurality of spring discs which have arc faces and are alternately inserted with either side at the pivotal axle.

16. The positioning device for hinge structure as defined in claim 11, wherein the elastic part is a spring.

17. The positioning device for hinge structure as defined in claim 11, wherein at least a wear resistant plate is disposed between the first and second pivotal portions and is formed to have a plurality of oil holes on its surface, and each wear resistant plate is protrudingly disposed with an engagement tenon so as to be engaged into the engagement slots pre-formed at an adjoining pivotal portion.

18. The positioning device for hinge structure as defined in claim 11, wherein a torsion spring is disposed between the fixed part and the movable part and enclosingly inserted with a sleeve before being inserted by the pivotal axle, and the ends of the torsion spring are abutted against the fixed part and the rotatable part, respectively.

19. The positioning device for hinge structure as defined in claim 11, wherein the linking portion is a notch, the connection portion is an inserted handle, which is inserted into the notch, and an axle pin is passed through the positioning hole of the notch and the pin hole of the inserted handle to establish a rotatable pivotal connection.

20. The positioning device for hinge structure as defined in claim 11, wherein the movable end of the cam member is connected with a handle.

21. The positioning device for hinge structure as defined in claim 11, wherein a gasket is disposed at both sides of the elastic part for the insertion of the pivotal axle and formed to have oil grooves at its surfaces.
